(19) United States
(12) Patent Application Publication
(10) Pub. No.: US 2011/0296965 A1
(43) Pub. Date: Dec. 8, 2011

(54) METHOD AND DEVICE FOR STRIPPING FIBERS OF A FIBER BUNDLE

(75) Inventors: Inka Manek-Hönninger, Cestas (FR); Marcin Michal Kozak, Teltow (DE); Holger Kühn, Jena (DE)

(73) Assignee: JT OPTICAL ENGINE GMBH + CO. KG, Jena (DE)

(21) Appl. No.: 13/139,233

(22) PCT Filed: Dec. 11, 2008
(86) PCT No.: PCT/EP2008/010554

§ 371 Date: Aug. 23, 2011

(51) Int. Cl. G02B 6/245; B26D 7/10; B26D 7/27; B26D 7/18

(52) U.S. Cl. 83/27; 83/169

(57) ABSTRACT

The invention relates to a method for stripping fibers of a fiber bundle, wherein each fiber comprises a core and a cladding, wherein the fibers are disposed next to each other on an underlayment such that they extend along a first direction, a cutter extending transverse to the first direction cuts into the claddings and simultaneously all fibers are rolled about the longitudinal axis thereof on the underlayment, so that the cutter generates a cut running in the circumferential direction in each cladding, the fiber bundle is then immersed in a chemical solvent for a prescribed period of time, in order to pre-weaken the bond between the cladding and the core, and the pre-weakened cladding segments are mechanically pulled off of the fiber cores.

The present invention relates to a method and an apparatus for stripping fibres of a fibre bundle.

Chemical, mechanical and mechanical-chemical methods are known for stripping individual fibres of a fibre bundle. However, all of these known methods are elaborate, and some are hazardous because of the chemicals used. Furthermore, defined stripping as far as a predefined edge is difficult and, in the case of the mechanical methods, very high, unwanted mechanical loads are often present. Moreover, frequently the known methods are not suitable for fibre bundles, such that each fibre of a fibre bundle must be stripped individually.

Proceeding therefrom, it is the object of the invention to provide a method for stripping fibres of a fibre bundle, by means of which stripping as far as a predefined location on the fibres of the fibre bundle can be effected easily and rapidly with little mechanical loading of the fibres. Further, a corresponding apparatus for stripping fibres of a fibre bundle is to be provided.

The object is achieved, according to the invention, by a method for stripping optical fibres of a fibre bundle, wherein each fibre has a core and a sheath, in which

a) the fibres are disposed next to each other on a base, such that they extend along a first direction,

b) a cutter extending transverse to the first direction is used to cut into the sheaths and simultaneously all fibres are rolled about their longitudinal axis on the base, such that the cutter produces a cut running in the circumferential direction in each sheath,

c) the fibre bundle is then immersed, as far as the cuts in the fibres, in a chemical solvent for a predefined period of time, in order to pre-weaken the bond between the sheath and the core, and

d) the pre-weakened sheath portions are mechanically drawn off the fibre cores.

By means of this method, it is possible for all fibres of the fibre bundle to be stripped simultaneously, such that the stripping can be performed rapidly. Further, because of the cuts, a defined tear-off edge is produced, such that the stripped regions of the fibres all commence at the same level in the fibre bundle. Owing to the pre-weakening by means of the chemical solvent, the mechanical loads during the drawing off of the pre-weakened sheath portions are extremely small, such that damage to the exposed fibre cores can be prevented.

Here, the sheath of the fibre denotes, in particular, the part of the fibre that is removed from the fibre. Here, the core of the fibre is, in particular, the remaining part of the fibre. In the case of a single-core fibre, the commonly used terminology is applicable, such that the core of the single-core fibre is the fibre core in the meaning of the invention, and the sheath of the single-core fibre is the fibre sheath in the meaning of the invention. In the case of, for example, a double-core fibre, the core and the so-called cladding constitute the core in the meaning of the invention, and the sheath of the double-core fibre is the sheath in the meaning of the invention. Clearly, it can also be the case that the cladding is also to be removed. In this case, the cladding and sheath of the double-core fibre constitute the sheath in the meaning of the invention, and the core of the double-core fibre is the core in the meaning of the invention. The same applies to fibres having, for example, a triple or quadruple core, or to other fibres having at least one core and one sheath.

In the case of a large number of fibres to be stripped, division into technologically appropriate bundles is advantageous.

Ketones, dichloromethane or another halogenated solvent can be used as a solvent. Such halogenated solvents are particularly suitable, in particular, in the case of fibres having an acrylate sheath. The fibre core can be a glass fibre core.

In the case of the method according to the invention, in step b) the fibres can be rolled to such an extent that, in the case of each fibre, the cut extends along the entire circumference. In particular, each fibre can be rolled at least twice along its entire circumference, such that it is ensured that all cuts are fully circumferential in all fibres.

In the case of the method, the cutter in step b) can extend parallel to the base. This is advantageous in that the cut depth is the same in all fibre sheaths.

Further, in step b), a second cutter can be provided, which is disposed such that the fibres are located between the two cutters. In this case, the fibres are cut simultaneously from above and below. As a result, the distance by which the fibres are rolled, for example, can be approximately halved in comparison with the case in which only one cutter is provided, in order to achieve the same cut length along the circumference.

In step b), the rolling of the fibres can be effected by a plate, which bears on the fibres and which is moved transverse to the first direction. Alternatively, it is possible for two plates that bear on the fibres to be moved transverse to the first direction, in order to effect the rolling. In the case with the two plates, the cutter is preferably located between the plates, as viewed along the first direction. The desired rolling can be effected easily by means of the plate or plates. The underside of the plates that bears on the fibres preferably has a high friction, or coefficient of friction. The same applies to the corresponding portion of the base. The rolling can thereby be effected in a reliable manner.

The cutter or cutters can each be produced from a non-corroding or low-corrosion material or materials such as, for example, from stainless steel, ceramic, diamond or particularly hard plastic.

Further, the cutter or cutters, in particular in the case of cutters made of metallic materials, can be heated before or during step b), in order to achieve an optimal cut, wherein the temperature is advantageously adapted to the type and thickness of the fibre sheath. Typically, such a temperature is in the range of up to 120° C.

Furthermore, in step b), vibrations, in particular high-frequency vibrations such as, for example, ultrasonic vibrations, can be applied to the cutter or cutters, in order thus to enable a more effective cutting of the fibres, since this causes, for example, scoring of the fibre sheaths in regions adjoining the cut. Vibrations can be applied to the cutter(s) in such a way that the cutter(s) is/are made to vibrate preferably in the longitudinal direction thereof and/or perpendicularly thereto, in the direction of the cut depth.

Further provided is an apparatus for stripping fibres of a fibre bundle, wherein each fibre has a core and a sheath, wherein the apparatus comprises a cutting module that has a base, a holding unit, a fibre rotating unit and a cutting unit, and a pre-weakening module that has an immersion unit and a container having a chemical solvent, wherein the holding unit holds the fibre bundle on the base in such a way that the fibres are disposed next to each other and extend along a first direction, the cutting unit has a cutter that extends transverse to the first direction and that cuts into the sheaths of the fibres, the fibre rotating unit, when the cutter cuts into the sheaths, rotates all fibres simultaneously about their longitudinal axis on the base, such that the cutter produces a cut running in the circumferential direction in each sheath, and wherein the immersion unit immerses the fibre bundle, as far as the cuts in the fibres, in the solvent in the container for a predefined period of time, in order to pre-weaken the bond between the sheath and the core.

By means of the apparatus, the desired stripping can be performed easily, since it is then necessary only for the pre-weakened sheath portions to be mechanically drawn off, which is possible because of the pre-weakening. Owing to the cuts, it is also only the pre-weakened sheath portions that are actually drawn off, such that defined stripping is effected.

The apparatus can have a holding plate, on which the fibre bundle is fixed, wherein the holding plate is insertable both into the cutting module and into the pre-weakening module, and the cutting module and the pre-weakening module, with the holding plate inserted, are able to perform, respectively, the intended cutting and normal pre-weakening without the fibre bundle having to be re-fixed on the holding plate. The operation of the apparatus is thereby facilitated.

In the case of the apparatus, the fibre rotating unit can roll the fibres to such an extent that, in the case of each fibre, the cut extends along the entire circumference. This results in a defined sheath edge after the pre-weakened sheath portions have been drawn off.

In particular, the cutter of the cutting unit can extend parallel to the base. As a result, the cut depth of the cutter is the same in all sheaths of the fibres.

The cutting unit can have a second cutter, which is disposed such that the fibres are located between the two cutters.

Further, it is possible for the cutter of the cutting unit to have an integrally formed cutting portion for each fibre of the fibre bundle, such that a short rolling distance is sufficient to produce a complete circumferential cut.

In the case of the apparatus according to the invention, the cutting module can have a plate, which bears on the fibres and which is moved transverse to the first direction, in order to roll the fibres. In particular, the cutting module can have two plates that bear on the fibres and that can be moved transverse to the first direction, in order to roll the fibres, wherein the cutter is disposed between the two plates, as viewed along the first direction. A very uniform rolling is possible as a result.

Preferably, the cutter or cutters is/are produced from a non-corroding or low-corrosion material such as, for example, from stainless steel, ceramic, diamond or particularly hard plastic.

Further, the apparatus according to the invention can have a source for heating the cutter or cutters, such that, in particular, metallic cutters can be heated in order to achieve an optimal cut, wherein the temperature is advantageously adapted to the type and thickness of the fibre sheath.

Furthermore, the apparatus can have a vibration source, in particular a high-frequency vibration source such as, for example, an ultrasound source, which can be applied to the cutter or cutters, in order thus to enable a more effective cutting of the fibres. This can cause, for example, scoring of the fibre sheaths in regions adjoining the cut. The vibration source can apply vibrations to the cutter(s) in such a way that the cutter(s) is or are made to vibrate in the longitudinal direction thereof and/or perpendicularly thereto, in the direction of the cut depth.

In a particular embodiment, the apparatus according to the invention is equipped with at least one settable spacer for regulating the distance of the cutter or cutters. This enables the apparatus to be easily adapted to differing fibre types and fibre thicknesses.

It is understood that the features mentioned above and those yet to be explained in the following are applicable, not only in the stated combinations, but also in other combinations or singly, without departure from the scope of the present invention.

The invention is explained by way of example in yet greater detail in the following with reference to the attached drawings, which also disclose features essential to the invention. There are shown in:

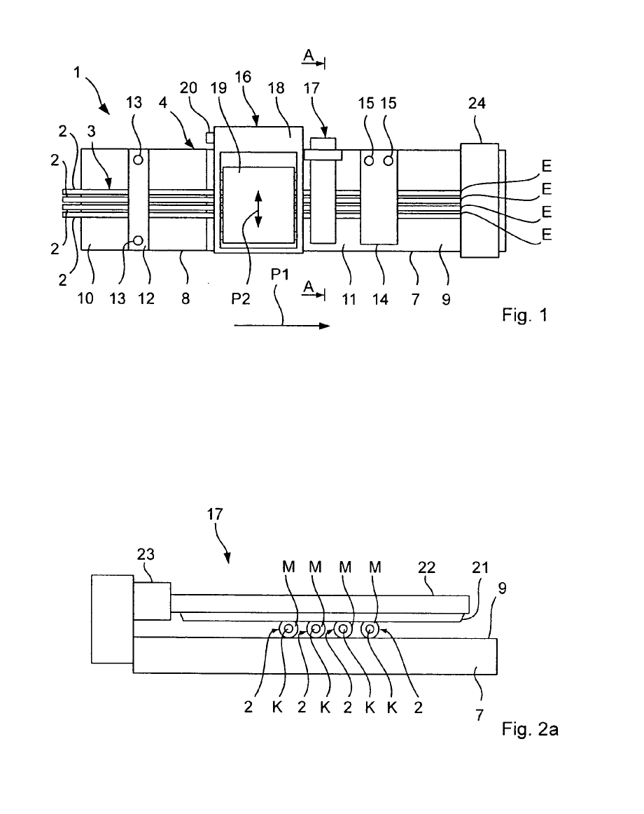

FIG. 1 a schematic view of a cutting module of a first embodiment of the apparatus, according to the invention, for stripping fibres of a fibre bundle;

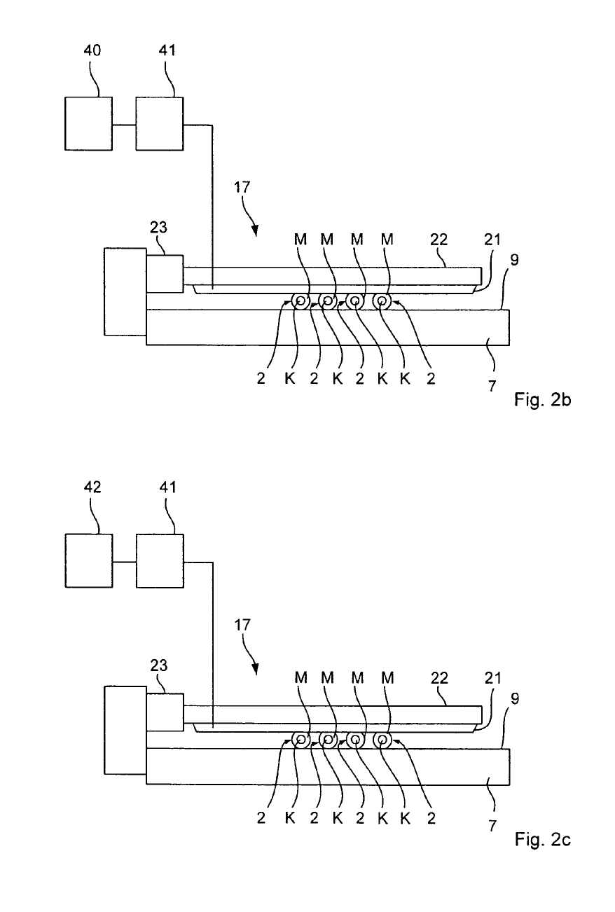

FIG. 2a an enlarged sectional view along the section line A-A of FIG. 1;

FIG. 2b an enlarged sectional view along the section line A-A of FIG. 1, as an embodiment having an additional heating source;

FIG. 2c an enlarged sectional view along the section line A-A of FIG. 1, as an embodiment having an additional ultrasound source;

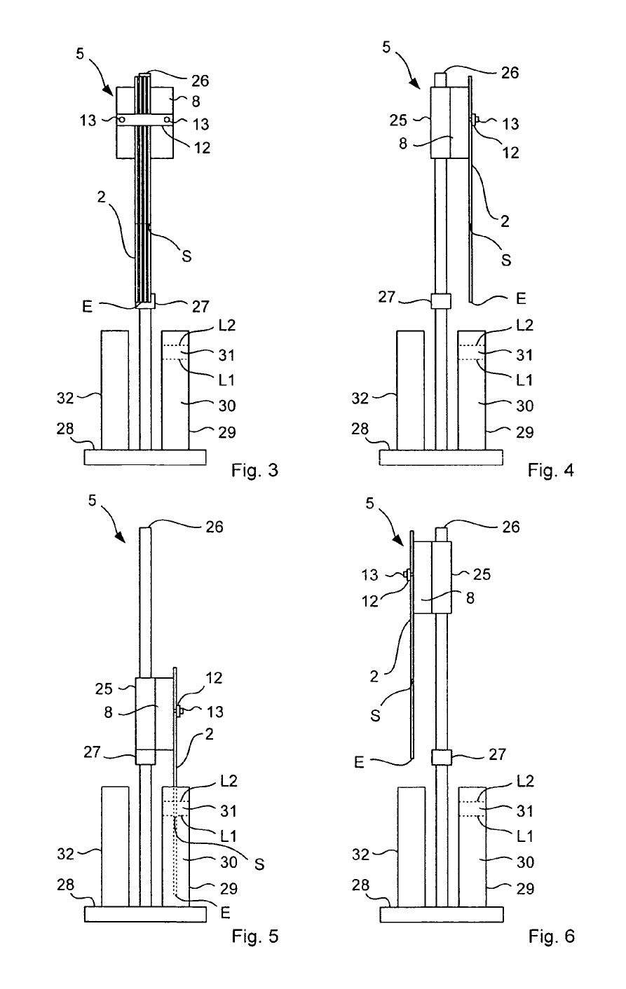

FIG. 3 a schematic view of a pre-weakening module of the first embodiment of the apparatus, according to the invention, for stripping fibres of a fibre bundle;

FIG. 4 a different position of the holding plate in the case of the pre-weakening module according to FIG. 3;

FIG. 5 a further position of the holding plate in the case of the pre-weakening module according to FIG. 3;

FIG. 6 yet a further position of the holding plate in the case of the pre-weakening module of FIG. 3;

FIG. 7 a schematic view of a draw-off module of the first embodiment of the apparatus, according to the invention, for stripping fibres of a fibre bundle;

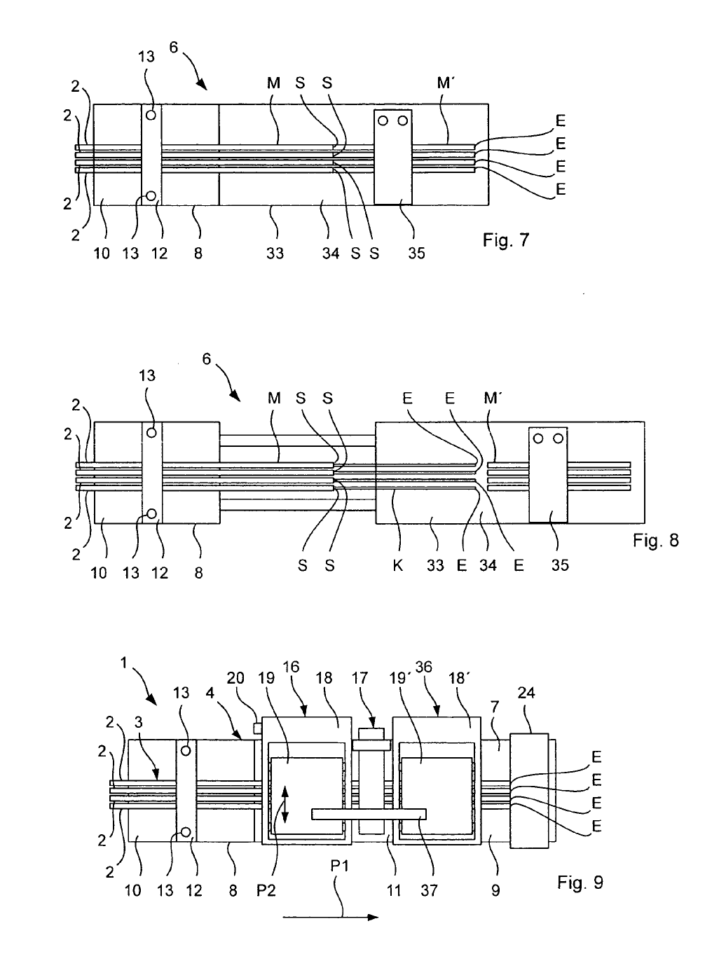

FIG. 8 the draw-off module in a position differing from that in FIG. 7;

FIG. 9 a modification of the cutting module of FIG. 1;

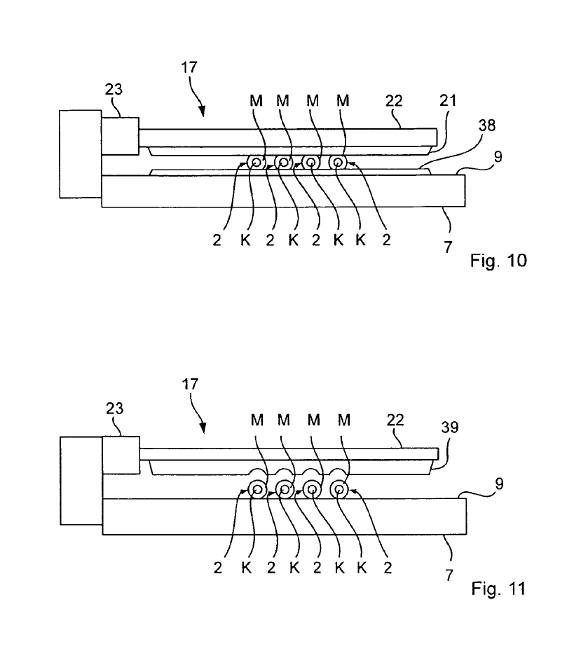

FIG. 10 a modification of the cutting unit 17 of FIGS. 2a-c;

FIG. 11 a further modification of the cutting unit 17 of FIGS. 2a-c;

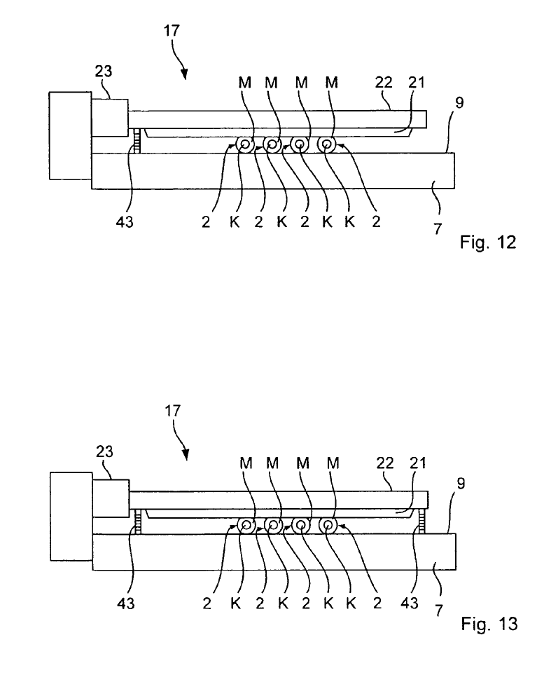

FIG. 12 a further modification of the cutting unit 17 of FIGS. 2a-c; and

FIG. 13 a further modification of the cutting unit 17 of FIGS. 2a-c.

In the case of the embodiments shown in FIGS. 1-8, the apparatus 1, according to the invention, for stripping optical fibres 2 (or optical waveguides) of a fibre bundle 3 comprises a cutting module 4 (FIGS. 1 and 2a-2c), a pre-weakening module 5 (FIGS. 3-6), and a draw-off module 6 (FIGS. 7 and 8).

The cutting module 4 comprises a carrier plate 7 and a holding plate 8, which is connected to the carrier plate 7 and whose top sides 9, 10 constitute a continuous, flat bearing surface 11.

On the bearing surface 11, the fibre bundle 3 lies such that the individual fibres 2 lie next to each other and extend substantially parallel to each other along a first direction, which is indicated by the arrow P1. By means of a first clamping web 12, which is fastened on the holding plate 8 by screws, the fibres 2 are pressed against the top side 10 of the holding plate 8 and are thereby held. At a distance from the first clamping web 12 along the first direction P1, a second clamping web 14 is fastened on the carrier plate 7 by screws 15, such that the fibres 2 are pressed against the top side 9 of the carrier plate 7 and are thereby clamped in between the second clamping web 14 and the carrier plate 7.

Disposed between the two clamping webs 12 and 14 there is a fibre rotating unit 16 and a cutting unit 17. The fibre rotating unit 16 has a frame 18, in which a plate 19 is mounted so as to be displaceable in a direction transverse to the first direction P1, as indicated by the double arrow P2. The fibre rotating unit 16 can be in its operating position, shown in FIG. 1, in which the underside of the plate 19 is in contact with the fibres 2, and can be brought into a non-operative position, not shown, in which it is not in contact with the fibres 2. For example, the fibre rotating unit 16 can be swiveled upwards about the schematically indicated axle 20, such that there is no longer any contact between the underside of the plate 19 and the fibres 2.

As can best be seen from the sectional representation of FIG. 2a, the cutting unit 17 has a cutter 21, which extends transverse to the first direction P1 and is fastened to a cutter carrier 22. The cutter carrier 22 is fastened to an adjusting slide 23, represented schematically, via which the distance of the cutter carrier 22, and thus of the cutter 21, from the top side 9 of the carrier plate 7 can be set (in particular, by control or regulation). In the case of the position of the adjusting slide 23 shown in FIG. 2a, in the case of each of the four fibres 2 the cutter 21 cuts into the sheath M of the fibre 2, but not as far as the fibre core K.

The cutting unit 17 being in this position, the plate 19 is now moved inside the frame 18, with the result, owing to the contact between the underside of the plate 19 and the fibres 2, that the fibres 2 are rolled about their longitudinal axes on the bearing surface 11, transverse to the first direction P1. A cut S running in the circumferential direction is thereby made in each sheath M of the fibres 2 by means of the cutter 21. To enable this rolling, the clamping force of the two clamping webs 12 and 14 is selected such that the fibres 2 can also execute their rolling motion under the clamping webs 12 and 14. Alternatively, however, it is also possible for at least one of the clamping webs 12, 14 to fix the fibres 2 such that they cannot rotate under the clamping web 12, 14, or clamping webs 12, 14. In this case, fibres are twisted, owing to the rolling motion in the region of the cutting unit. The displacement path of the plate 19 along the direction transverse to the first direction P1 is preferably selected such that each of the fibres is rolled at least once along its entire circumference (at least in the region of the cutting unit 17), such that the cut S produced is a fully circumferential cut S.

FIG. 2b shows an embodiment having an additional heating source 40 for heating the cutter 21, which is connected to the heating source 40 through an appropriate control unit 41.

FIG. 2c shows an embodiment having an additional ultrasound source 42, which applies ultrasound to the cutter 21 via the control unit 41. As a result, the cutter 21 can vibrate, for example along its longitudinal direction (in FIG. 2c, from left to right) and/or perpendicularly thereto, in the direction of the cut depth (in FIG. 2c, from top to bottom).

It is understood that, in the case of the embodiments according to FIGS. 2b and 2c, a plurality of heating sources or a plurality of vibration sources, in particular high-frequency vibration sources, can also be used. Clearly, combinations of the embodiments of FIGS. 2b and 2c are also possible.

As further shown by FIG. 1, the carrier plate 7 has a fibre stop 24, on which the front ends E of the fibres 2 bear. As a result, all circumferential cuts S in the fibres 2 of the fibre bundle 3 are at the same level (or the distance from the front end E of the fibres 2 to the circumferential cut S is of equal size for all fibres 2 of the bundle 3). The fibre stop can be displaced along the first direction. The distance of the cuts S from the front ends E can thereby be defined.

After the cuts S have been made, the fibre rotating unit 16 is brought into its non-operative position, the cutter 21 is moved upwards relative to the top side 9 of the carrier plate 7 by means of the adjusting slide 23, such that the cutter 21 no longer cuts into the sheath M of the fibres 2, and the screws 15 of the second clamping web 14 are undone, such that the fibre bundle 3 can be removed, together with the holding plate 8, from the cutting module 4.

The holding plate 8, together with the fibre bundle 3, is then fastened to an adapter 25 of the pre-weakening module 5, as shown schematically in FIG. 4. The adapter 25 sits on a rod 26 of the pre-weakening module 5 and, on the one hand, can be rotated about the longitudinal axis of the rod 26 (FIGS. 3, 4 and 6) and, on the other hand, can be displaced along the longitudinal direction of the rod 26 (FIG. 5).

The rod 26 has a stop 27, and is fastened on a base plate 28 that carries a container 29, for receiving a solvent 30, and an ultrasound bath 32.

The container 29 is filled with a solvent 30, wherein dichloromethane (DCM) is used here as the solvent. The fill level of the solvent 30 is indicated by the broken line L1. As indicated by the broken line L2, a water layer 31 is provided on the dichloromethane 30. The water layer serves, on the one hand, as a vapour block, in order that the solvent 30 does not evaporate, and, on the other hand, as a creep stop, as described in yet greater detail in the following.

The vapour block serves, in particular, to protect the user of the pre-weakening module from hazardous vapours of the solvent.

The holding plate 8 is now rotated, starting from the position of FIG. 3, about the rod 26 (FIG. 4) and displaced along the longitudinal direction of the rod 26 to such an extent that the adapter 25 bears on the stop 27, as shown in FIG. 5. The position of the stop 27 in this case is selected such that the fibres 2 are immersed in the solvent 30 as far as their circumferential cut S. The circumferential cut is thus located exactly at the boundary surface between the solvent 30 and the water layer 31 (line L1). The solvent 30 causes the bond between the acrylate sheath M and the glass core K to be dissolved in the region from the front end E of the fibres 2 as far as the circumferential cut S. It is not possible for the solvent 30 to creep up over the circumferential cut S, because of the water layer 31, which thus serves as a creep stop. After a predefined period of time of action of the solvent 30, the adapter 25, with the holding plate 8, is pushed upwards, such that the fibres are drawn out of the container 29. The adapter 25, with the holding plate 8, can then be rotated about the rod (as indicated in FIG. 6), and then immersed in the ultrasound bath 32 for cleaning (not shown).

The thus pre-weakened and cleaned fibres 2 are separated, together with the holding plate 8, from the adapter 25 and inserted in the draw-off module 6 (FIG. 7). The draw-off module 6 has a substrate plate 33, to which the holding plate 8 is connected such that the top side 34 of the substrate plate 33 is in alignment with the top side 10 of the holding plate 8. A clamping element 35 is then applied over the pre-weakened portions of the fibres 2, and is connected to the substrate plate 33, such that the pre-weakened portions are clamped onto the substrate plate 33.

The substrate plate 33 (seen in FIGS. 7 and 8) is then moved to the right, such that the pre-weakened sheath portions M′ of the fibres 2 are drawn off to the right and the fibre cores K are exposed. Owing to the circumferential cuts S and the selective weakening from the front ends E to only as far as the circumferential cuts S, a sheath end edge of the fibres 2 is obtained that, on the one hand, is in alignment. On the other hand, the sheath edge is very sharp and precisely defined.

Clearly, it is also possible for a person, after releasing the holding plate 8 from the adapter 25, to draw off the pre-weakened sheath portions M′ by hand, such that it is possible to dispense with the draw-off module 6 in this case.

In the case of the embodiment described hitherto, the front ends E of the fibres 2 were all at the same level. This can be, but need not be, the case. It is quite possible for the fibre ends of the fibres 2 not to be at the same level. For this purpose, it is possible, for example, to dispense with the fibre stop 24 in the case of the cutting module 4.

A modification of the cutting module 4 of FIG. 1 is shown in FIG. 9. Elements that are the same are denoted by the same references and, to avoid unnecessary repetitions, reference is made to the corresponding statements above. Unlike the cutting module 4 of FIG. 1, in the case of the cutting module 4 of FIG. 9 a second fibre rotating unit 36 is provided, which replaces the second clamping web 14 in FIG. 1. In its structure, the second fibre rotating unit 36 is like the first fibre rotating unit 16, and has a frame 18′ and a plate 19′ guided so as to be displaceable in the frame, transverse to the first direction P1. The two plates 19 and 19′ are mechanically coupled via the element 37, such that they can be moved simultaneously. The two fibre rotating units 16 and 36 render possible an extremely uniform rolling of the fibres 2, and thus a very uniform circumferential cut S.

A modification of the cutting unit 17 of FIG. 1 and FIG. 9 is shown in FIG. 10. This modification differs from the cutting apparatus 17 described hitherto in that a cutter 38, which extends transverse to the first direction P1, is also disposed on the top side 9 of the carrier plate 7. The cutter 38 is preferably located directly beneath the cutter 21. In this case, the fibres 2 need only be rolled over half of their circumference along their longitudinal axis, in order for the cut S to extend over the entire circumference.

A further modification of the cutting unit 17 of FIGS. 1 and 9 is shown in FIG. 11. In the case of this modification there is realized, instead of the cutter 21 according to FIGS. 2a-2c, a cutter 39 that has an adapted cutting shape (here, approximately semicircular) for each of the fibres 2. For clearer representation, in FIG. 11 the cutter 39 is shown at a distance from the fibres 2. Clearly, in the actual cutting operation, the cutter 39 sits in the sheaths M. Owing to the substantially semicircular shaping of the cutter 39 in the region of each fibre 2, in the rolling of the fibres 2, likewise, only approximately half of one revolution is required to produce a cut S that goes around the entire circumference. In the case of the cutter 39 having the integrally formed shaping of the cutter in the region of the fibres 2, it can be necessary for the cutter 39 to be moved parallel to the motion of the plate 19 or 19′, transverse to the first direction P1. This can be realized, for example, in that a coupling element, similar to the element 37 of FIG. 9, is used.

Further, according to a further modification of the cutting unit 17 (FIG. 12), a settable spacer 43 can be disposed such that, by means thereof, the minimal distance between the cutter 21 and the top side 9 is set such that the cut depth is defined thereby. A regulated distance setting is thereby possible. This enables the cutting unit 17 to be set very precisely to a fibre diameter, such that, in the cutting operation, it is ensured that cuts are made as deeply as possible into the respective sheaths M, but are not made into the fibre cores K. The design having two spacers 43 is shown in FIG. 13.

The controlled or even regulated distance setting enables the cutting unit 17 to be used for various fibre types and/or fibre thicknesses, it being necessary only to adapt the distance and, if appropriate, exchange the cutter(s) 17.

1. A Method for stripping fibres of a fibre bundle, wherein each fibre has a core and a sheath, comprising:
a) disposing the fibres next to each other on a base, such that they extend along a first direction;
b) cutting the sheaths with a cutter extending transverse to the first direction and simultaneously rolling all fibres about their longitudinal axis on the base, such that the cutter produces a cut running in a circumferential direction in each sheath;
c) immersing the fibre bundle, as far as the cuts in the fibres, in a chemical solvent for a predefined period of time, in order to pre-weaken the bond between the sheath and the core; and
d) mechanically drawing the pre-weakened sheath portions off the fibre cores.

2. The Method according to claim 1, wherein in step b) the fibres are rolled to such an extent that, in the case of each fibre, the cut extends along the entire circumference.

3. The Method according to claim 1, wherein the cutter in step b) extends parallel to the base.

4. The Method according to claim 1 wherein in step b), a second cutter is provided, which is disposed such that the fibres are located between the two cutters.

5. The Method according to claim 1 wherein the rolling of the fibres in step b) is effected by a plate, which bears on the fibres and which is moved transverse to the first direction.

6. The Method according to claim 1 wherein the rolling of the fibres in step b) is effected by two plates, which bear on the fibres and which are moved transverse to the first direction, wherein the cutter is disposed between the two plates, as viewed along the first direction.

7. The Method according to claim 1 wherein the cutter is heated at least one of before and during step b).

8. The Method according to claim 1 wherein vibrations are applied to the cutter in step b).

9. An Apparatus for stripping fibres of a fibre bundle, wherein each fibre has a core and a sheath, comprising:
a cutting module including a base, a holding unit, a fibre rotating unit and a cutting unit; and
a pre-weakening module including an immersion unit and a container including a chemical solvent,
wherein the holding unit holds the fibre bundle on the base in such a way that the fibres are disposed next to each other and extend along a first direction, the cutting unit including a cutter that extends transverse to the first direction and that cuts into the sheaths of the fibres, the fibre rotating unit, when the cutter cuts into the sheaths, rotates all fibres simultaneously about their longitudinal axis on the base, such that the cutter produces a cut running in the circumferential direction in each sheath, and wherein the immersion unit immerses the fibre bundle, as far as the cuts in the fibres, in the solvent in the container for a predefined period of time, in order to pre-weaken the bond between the sheath and the core.

10. The Apparatus according to claim 9, wherein the fibre bundle is fastened on a holding plate that is insertable into the cutting module and into the pre-weakening module, wherein, in the inserted state, no alteration of the fastening of the fibre bundle on the holding plate is necessary for use of the cutting module or of the pre-weakening module.

11. The Apparatus according to claim 9 wherein the fibre rotating unit rolls the fibres to such an extent that, in the case of each fibre, the cut extends along the entire circumference.

12. The Apparatus according to claim 9, wherein the cutter of the cutting unit extends parallel to the base.

13. The Apparatus according to claim 9, wherein the cutting unit includes a second cutter, which is disposed such that the fibres are located between the two cutters.

14. The Apparatus according to claim 9, wherein the cutting module includes a plate, which bears on the fibres and which is movable transverse to the first direction, in order to roll the fibres.

15. The Apparatus according to claim 9, wherein the cutting module has includes two plates, which bear on the fibres and which can be moved transverse to the first direction, in order to roll the fibres.

16. The Apparatus according to claim 15, wherein the cutter is disposed between the two plates, as viewed along the first direction.

17. The Apparatus according to claim 9, wherein the cutting module includes a heating source for heating the cutter.

18. The Apparatus according to claim 9, wherein the cutting module includes a vibration source for applying vibrations to the cutter.

19. The method according to claim 7, wherein vibrations are applied to the cutter in step b).

20. The apparatus according to claim 17, wherein the cutting module includes a vibration source for applying vibrations to the cutter.
